(19) United States
(12) Patent Application Publication
(10) Pub. No.: US 2004/0094377 A1
(43) Pub. Date: May 20, 2004

(54) Apparatus for absorbing shock

(76) Inventor: Seungsang Jo, Kyonggi-do (KR)

Correspondence Address: HARNESS, DICKEY & PIERCE, P.L.C., P.O. BOX 828, BLOOMFIELD HILLS, MI, 48303, US

(21) Appl. No.: 10/471,333

(22) PCT Filed: Oct. 30, 2001
(86) PCT No.: PCT/KR01/01833

(30) Foreign Application Priority Data
Aug. 10, 2001 (KR) 2001/24402 U

(51) Int. Cl. F16F 7/12

(52) U.S. Cl. 188/376

(57) ABSTRACT

The object of this invention is to provide an apparatus for absorbing shock. This apparatus stepwise absorbs impact energy applied thereto in case of a collision of automobiles or a sudden drop of elevators to protect passengers. In an embodiment, the shock absorbing apparatus includes two or more impact panels (110, 120, 130, 140, 150 and 160), and a plurality of shock absorbing members (210, 220, 230, 240 and 250) installed between the impact panels, and each engraved with a broken line so as to crash along the broken line to absorb impact. In another embodiment, the apparatus includes two or more impact panels (410, 420, 430, 440, 450 and 460) arranged in parallel to each other, and each engraved with at least one broken line so as to crash along the broken line to absorb impact, and a panel support member (600) supporting the parallely arranged impact panels.

### TECHNICAL FIELD

The present invention relates, in general, to apparatuses for absorbing shock in case of a collision of automobiles or a sudden drop of elevators and, more particularly, to a shock absorbing apparatus for stepwise absorbing impact energy applied thereto in case of such a collision or drop to protect passengers.

### BACKGROUND ART

A variety of shock absorbing apparatuses, designed to protect passengers in case of a collision of automobiles or a sudden drop of elevators, have been proposed and used. However, such conventional shock absorbing apparatuses are problematic in that they cannot appropriately absorb impact energy applied thereto in case of such a collision or drop, thus sometimes failing to protect passengers.

In an effort to overcome such problems of conventional shock absorbing apparatuses, another shock absorbing apparatus designed to stepwise absorb impact energy has been proposed as disclosed in Korean Patent Application No. 1996-077055, entitled “shock absorbing apparatus for front frames of automobiles”.

However, the shock absorbing apparatus disclosed in the above Korean patent application is problematic in that the impact energies to be stepwise absorbed at the primary shock absorbing stage, second shock absorbing stage and third shock absorbing stage during an operation of the apparatus are not controllable, but are fixed in accordance with a selected shock absorbing material of the apparatus.

### DISCLOSURE OF THE INVENTION

Accordingly, the present invention has been made keeping in mind the above problems occurring in the prior art, and an object of the present invention is to provide a shock absorbing apparatus, which stepwise absorbs impact energy applied thereto in case of a collision of automobiles or a sudden drop of elevators to protect passengers.

Another object of the present invention is to provide a shock absorbing apparatus, which includes two or more impact panels, and a plurality of shock absorbing members installed between the impact panels and each engraved with a broken line so as to crash along the broken line to absorb impact in case of an application of impact having a momentum higher than a predetermined reference level thereto, and which thus stepwise absorbs impact energy in case of a collision of automobiles or a sudden drop of elevators and effectively minimizes impact transmitted to passengers.

A further object of the present invention is to provide a shock absorbing apparatus, in which two or more closed broken lines are engraved on each impact panel such that the broken lines extend along the entire edge of each impact panel so as to crash along the broken lines to absorb impact in case of an application of impact thereto, the broken lines of each impact panel having different depths such that the broken lines become deeper in a direction from the outermost broken line to the innermost broken line, thus appropriately controlling impact energy to be stepwise absorbed by the impact panels, in accordance with impacted areas on the panels.

A further object of the present invention is to provide a shock absorbing apparatus, in which two or more tubular-shaped shock absorbing members arranged to each other, the upper shock absorbing members and the lower shock absorbing members are arranged in intersectional direction and each engraved with a broken line straightly extending in parallel to the axis, so as to crash along the broken line to absorb impact in case of an application of the impact thereto.

A further object of the present invention is to provide a shock absorbing apparatus, in which the shock absorbing members are toroidal shaped and the broken lines engraved on said shock absorbing members include a broken line straightly extending in parallel to the inner axis of toroid.

In order to accomplish the above object, the primary embodiment of the present invention provides an apparatus for absorbing shock, comprising: two or more impact panels; and a plurality of shock absorbing members installed between the impact panels, and each engraved with a broken line so as to crash along the broken line to absorb impact in case of an application of the impact thereto.

In the above apparatus, the broken lines engraved on the shock absorbing members include a broken line straightly extending in parallel to the impact panels.

In the above apparatus, the shock absorbing members include a rectangular panel-shaped shock absorbing member jointed to two neighboring impact panels at its two opposite edges.

The rectangular panel-shaped shock absorbing member is jointed to the two neighboring impact panels to form an I-shaped cross-section.

The shock absorbing members may include a tubular-shaped shock absorbing member jointed to two neighboring impact panels at its opposite sides.

In such a case, the tubular-shaped shock absorbing member may be a cylindrical tubular-shaped shock absorbing member jointed to the two neighboring impact panels to form a [symbol] -shaped cross-section.

The second embodiment of the present invention provides an apparatus for absorbing shock, comprising: one or more impact panels arranged in parallel to each other, and each engraved with a broken line so as to crash along the broken line to absorb impact in case of an application of the impact thereto; and a panel support member supporting the parallely arranged impact panels.

In the above apparatus, the broken lines engraved on the impact panels include one or more closed broken lines extending along the entire edge of each impact panel.

In the apparatus, the number of closed broken lines engraved on each of the impact panels is two or more, with the depths of the closed broken lines on each impact panel being different from each other such that the broken lines become deeper in a direction from the outermost broken line to the innermost broken line.

The above apparatus may further comprise an additional shock absorbing means, such as an air bag, installed on the upper surface of the uppermost impact panel.

The third embodiment of the present invention provides an apparatus for absorbing shock, comprising; two or more tubular-shaped shock absorbing members arranged to each other, and each engraved with a broken line so as to crash along the broken line to absorb impact in case of an application of the impact thereto.

In the above apparatus, the broken lines engraved on the shock absorbing members include a broken line straightly extending in parallel to the axis, and the upper shock absorbing members and the lower shock absorbing members are arranged in intersectional direction.

The fourth embodiment of the present invention provides an apparatus for absorbing shock, comprising; the toroidal-shaped shock absorbing members on which the broken lines engraved include a broken line straightly extending in parallel to the inner axis of toroid.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a shock absorbing apparatus in accordance with the primary embodiment of the present invention;

FIG. 2 is a plan view of a first shock absorbing member included in the shock absorbing apparatus of FIG. 1;

FIG. 3 is a perspective view of a shock absorbing apparatus in accordance with the second embodiment of the present invention;

FIG. 4 is a plan view of a first impact panel included in the shock absorbing apparatus of FIG. 3;

FIG. 5 is a perspective view of a shock absorbing apparatus in accordance with the third embodiment of the present invention; and

FIG. 6 is a perspective view of a shock absorbing apparatus in accordance with the fourth embodiment of the present invention.

### BEST MODE FOR CARRYING OUT THE INVENTION

Reference now should be made to the drawings, in which the same reference numerals are used throughout the different drawings to designate the same or similar components.

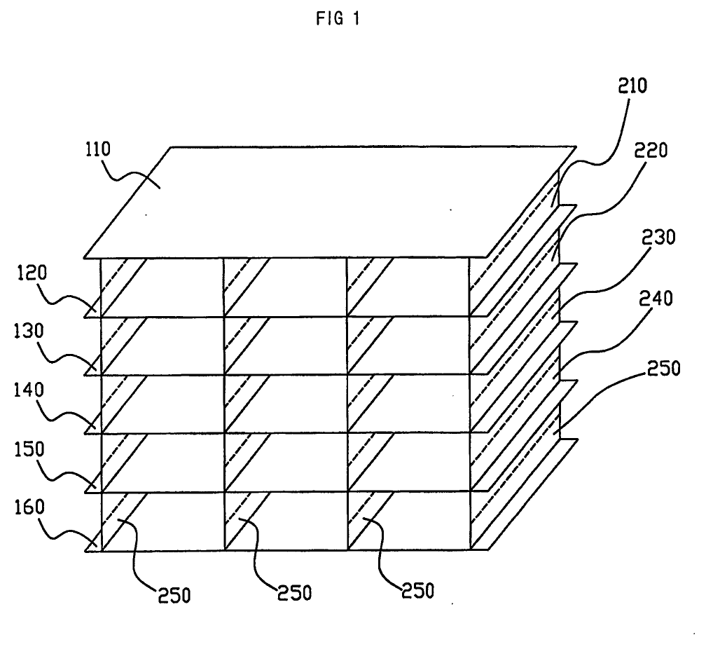

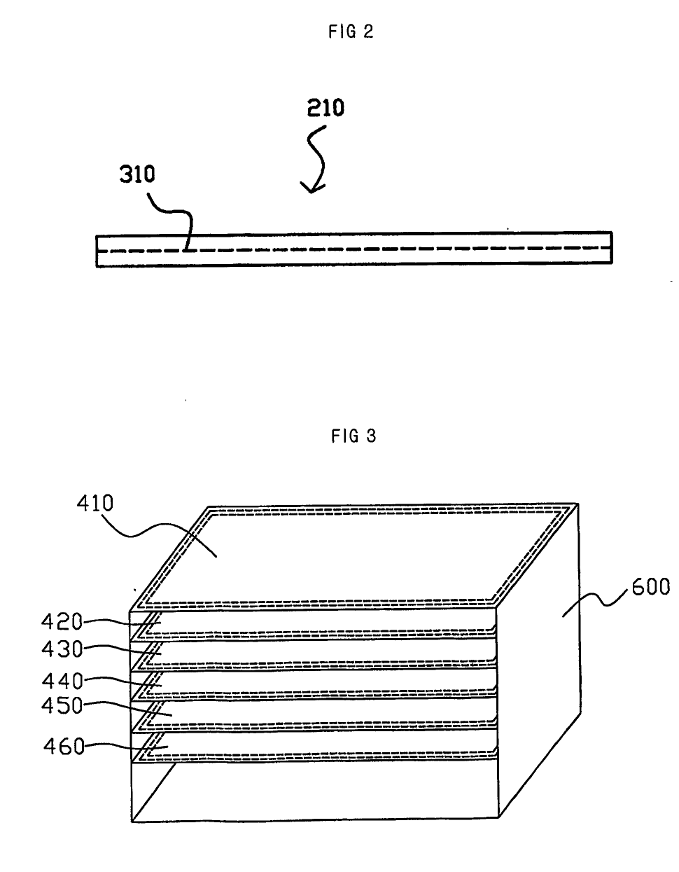

FIGS. 1 and 2 show a shock absorbing apparatus in accordance with the primary embodiment of the present invention, which is used in automobiles typically applying horizontal impact to passengers in case of a collision, or in elevators typically applying vertical impact to passengers in case of a sudden drop.

FIG. 1 is a perspective view of the shock absorbing apparatus according to the primary embodiment, and FIG. 2 is a plan view of a first shock absorbing member included in the shock absorbing apparatus of FIG. 1.

As shown in FIG. 1, the shock absorbing apparatus according to the primary embodiment has first to sixth impact panels 110, 120, 130, 140, 150 and 160, which are regularly and parallely arranged and each have a flat panel shape.

One or more first shock absorbing members 210, each having a longitudinal flat strip shape as best seen in FIG. 2, are positioned between and jointed to the first and second impact panels 110 and 120 such that each member 210 and the two impact panels 110 and 120 form an I-shaped cross-section.

As shown in FIG. 2, the first shock absorbing members 210 are each engraved with a broken line 310 so as to crash along the broken line 310 into pieces to absorb impact in case of an application of impact higher than a predetermined reference level thereto. The broken line 310 of each first shock absorbing member 210 straightly and axially extends in parallel to the first impact panel 110.

In the same manner, one or more second shock absorbing members 220 are positioned between and jointed to the second and third impact panels 120 and 130 to form an I-shaped cross-section. One or more third shock absorbing members 230 are positioned between and jointed to the third and fourth impact panels 130 and 140 to form an I-shaped cross-section. One or more fourth shock absorbing members 240 are positioned between and jointed to the fourth and fifth impact panels 140 and 150 to form an I-shaped cross-section. One or more fifth shock absorbing members 250 are positioned between and jointed to the fifth and sixth impact panels 150 and 160 to form an I-shaped cross-section.

Each of the second to fifth shock absorbing members 220, 230, 240 and 250 has a longitudinal flat strip shape as shown in FIG. 1. In addition, each of the second to fifth shock absorbing members is engraved with a broken line so as to crash along the broken line into pieces to stepwise absorb impact in case of an application of impact thereto. The broken lines of the second to fifth shock absorbing members each straightly and axially extend in parallel to the impact panels in the same manner as that described for the first broken line 310. The operational effect of the shock absorbing apparatus according to the primary embodiment will be described herein below with reference to FIGS. 1 and 2.

When a weighted material primarily collides against the first impact panel 110 and applies an impact to the panel 110, the panel 110 and the first shock absorbing members 210 absorb a part of the impact applied to the panel 110. In such a case, when the impact applied to the panel 110 exceeds a predetermined reference level, the first shock absorbing members 210 are broken along the first broken lines 310 into pieces.

In such a case, the impact energy absorbed by the first impact panel 110 and the first shock absorbing members 210 is determined by the depth and shape of the engraved broken line 310. That is, the impact energy absorbed by the first impact panel 110 and the first shock absorbing members 210 is reduced in inverse proportion to the depth of the first broken line 310. This means that the deeper the first broken line 310 is, the less impact energy is absorbed by the first impact panel 110 and the first shock absorbing members 210. Therefore, it is possible to control the impact energy absorbed at a first shock absorbing stage, performed by the first impact panel 110 and the first shock absorbing members 210, by controlling the depth and shape of the engraved first broken line 310.

When the weighted material with momentum attenuated by the first shock absorbing members 210 secondarily collides against the second impact panel 120 and applies an impact to the panel 120, the panel 120 and the second shock absorbing members 220 absorb a part of the impact applied to the panel 120 at a second shock absorbing stage in the same manner as that described for the first shock absorbing stage. In such a case, the second shock absorbing members 220 are broken along the second broken lines into pieces, and absorb a part of the impact applied to the second impact panel 120.

In the same manner, a third shock absorbing stage, a fourth shock absorbing stage and a fifth shock absorbing stage are sequentially performed to stepwise absorb impact energy, and so the shock absorbing apparatus does not absorb an excessively high impact at once.

In the primary embodiment, the shock absorbing apparatus has six impact panels. However, it should be understood that the number of impact panels of the apparatus may be changed as desired. That is, the apparatus of this invention may have five or less impact panels or seven or more impact panels if necessary.

In the primary embodiment, each shock absorbing member having a strip shape and associated impact panels are jointed together to form an I-shaped cross-section. However, it is possible to joint each shock absorbing member, having another shape in place of the strip shape, to associated impact panels such that an angle of inclination is formed between them.

In the primary embodiment, each impact panel has a flat panel shape. However, it should be understood that at least one of the impact panels may be designed such that it is curved to form a sine wave shape or another wave shape.

In the primary embodiment, the second to sixth impact panels have the same shape as that of the first impact panel 110. However, it is possible to design the second to sixth impact panels such that they have different shapes from that of the first impact panel 110. In a brief description, it is not necessary to design the first to sixth impact panels of this invention such that they have the same shape.

In addition, the engraved broken lines of the shock absorbing members according to the primary embodiment have the same profile. However, it should be understood that the broken lines of the shock absorbing members may be designed such that they have different profiles.

In the primary embodiment, each shock absorbing member is designed such that it has a longitudinal flat strip shape. However, it should be understood that the shock absorbing members may be designed such that at least one of the members has another shape in place of the flat strip shape. That is, at least one of the shock absorbing members may have a tubular-shaped cross-section or a sine wave-shaped cross-section. In such a case, the tubular-shaped shock absorbing member may be a cylindrical tubular-shaped shock absorbing member. When at least one of the shock absorbing members is designed to have a cylindrical tubular-shaped cross-section, the shock absorbing member is jointed to two impact panels to form a [symbol] -shaped cross-section.

In addition, no additional shock absorbing unit is installed in each gap between the impact panels of the shock absorbing apparatus according to this primary embodiment. However, it should be understood that a conventional shock absorbing means, such as an air bag, may be installed in each gap between the impact panels.

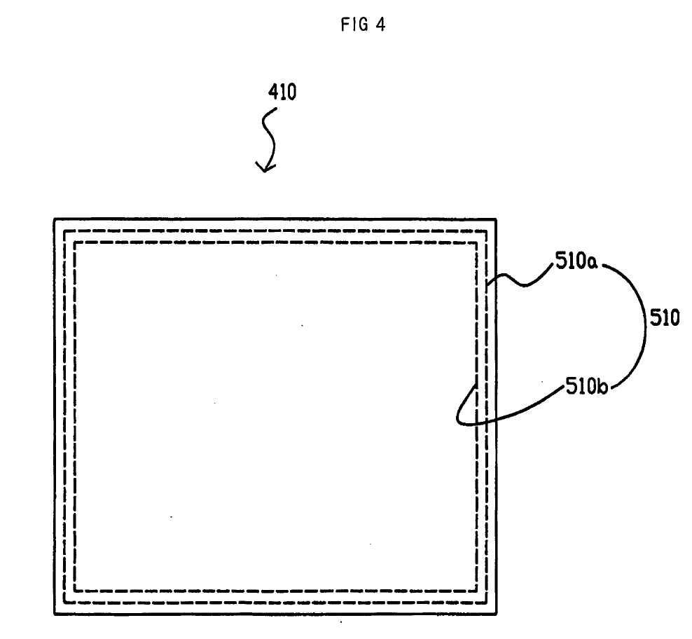

FIGS. 3 and 4 show a shock absorbing apparatus in accordance with the second embodiment of the present invention, which is preferably used in elevators typically applying vertical impact to passengers in case of a sudden drop.

FIG. 3 is a perspective view of the shock absorbing apparatus according to the second embodiment, and FIG. 4 is a plan view of a first impact panel included in the shock absorbing apparatus of FIG. 3.

As shown in FIG. 3, the shock absorbing apparatus according to the second embodiment has first to sixth impact panels, which are regularly and parallely arranged and each have a flat panel shape.

The parallely arranged first to sixth impact panels are supported at their opposite side edges by two panel support members 600. In such a case, each impact panel is perpendicularly jointed to the two panel support members 600 at right angles, and so each joint of the impact panels and the support members 600 form an L-shaped cross-section.

Referring to FIG. 4, two closed broken lines are engraved on each of the six impact panels 410, 420, 430, 440, 450 and 460 such that the broken lines extend along the entire edge of each impact panel. For example, the first impact panel 410 of FIG. 4 has two first broken lines 510 consisting of outer and inner closed broken lines 510a and 510b extending along the entire edge of the first impact panel 410.

In such a case, the two first broken lines 510 are designed such that the edge of the bottom wall of an elevator is positioned along the gap between the outer and inner closed broken lines 510a and 510b in case of a sudden drop of the elevator. In addition, the inner closed broken line 510b is relatively deeper so as to be broken in case of an application of small impact energy, while the outer closed broken line 510a is relatively shallow so as to be broken only in the application of large impact energy.

As shown in FIG. 3, the second impact panel 420 is arranged under the first impact panel 410 while being parallely spaced apart from the first panel 410 at an interval. Of course, the second impact panel 420 is jointed to the two panel support members 600 at its opposite side edges. In the same manner, the third impact panel 430 is arranged under the second impact panel 420. The fourth and fifth impact panels 440 and 450 are sequentially and parallely arranged under the third impact panel 430, and the sixth impact panel 460 is arranged under the fifth impact panel while being parallely spaced apart from the fifth panel at an interval. The third to sixth impact panels are each jointed to the two panel support members 600 at their opposite side edges.

As described above, each of the second to sixth impact panels has two broken lines consisting of outer and inner closed broken lines extending along the entire edge of an associated impact panel. The profiles of the outer and inner closed broken lines of the second to sixth impact panels remain the same as those of the first impact panel 410.

The operational effect of the shock absorbing apparatus according to the second embodiment in case of a sudden drop of an elevator or a sudden falling of a person will be described herein below.

When an elevator suddenly falls onto the shock absorbing apparatus and impacts the first impact panel 410, the panel 410 is broken along the outer broken line 510a to perform a first shock absorbing stage, thus absorbing a part of the impact energy applied from the elevator thereto.

When the elevator with momentum attenuated by the first impact panel 410 secondarily impacts the second impact panel 420, the panel 420 absorbs a part of the impact at a second shock absorbing stage in the same manner as that described for the first shock absorbing stage. In such a case, the second impact panel 420 is broken along the outer broken line, and absorbs a part of the impact applied thereto.

In the same manner, third to sixth shock absorbing stages are sequentially performed to stepwise absorb impact energy applied from the elevator, and so the shock absorbing apparatus does not absorb excessively high impact at once.

When a person suddenly falls through an elevator passage onto the area inside the inner broken line 510b of the first impact panel 410, the panel 410 is broken along the deeper inner broken line 510b to perform a first shock absorbing stage, thus absorbing a part of the impact energy applied from the falling person to the first impact panel 410. In such a case, the impact energy absorbed by the first impact panel 410 broken along the inner broken line 510b is less than that absorbed by the first impact panel 410 broken along the outer broken line 510a.

When the falling person with momentum attenuated by the first impact panel 410 secondarily impacts the area inside the inner broken line of the second impact panel 420, the panel 420 absorbs a part of the impact at a second shock absorbing stage in the same manner as that described for the first shock absorbing stage. In such a case, the second impact panel 420 is broken along the deeper inner broken line, and absorbs a part of the impact applied from the falling person.

In the same manner, third to sixth shock absorbing stages are sequentially performed to stepwise absorb impact energy applied from the falling person, and so the shock absorbing apparatus does not absorb excessively high impact at once.

In the second embodiment, the shock absorbing apparatus has six impact panels. However, it should be understood that the number of impact panels in the apparatus may be changed to five or less, or seven or more if necessary.

In the second embodiment, the engraved broken lines of each impact panel are designed to extend along the entire edge of the impact panel. However, it should be understood that at least one of the broken lines of the first to sixth impact panels may be designed to have a profile different from that of the edge of an associated impact panel.

In the shock absorbing apparatus according to the second embodiment, the inner and outer broken lines of each impact panel have the same profile with different sizes. However, it should be understood that the inner and outer broken lines of the impact panels may be designed to have different profiles.

In the second embodiment, each impact panel has two broken lines consisting of inner and outer broken lines. However, it should be understood that each impact panel may have only one broken line, or may additionally have one or more middle broken lines engraved along the gap between the inner and outer broken lines.

In the second embodiment, the first impact panel 410 has a flat panel shape. However, it should be understood that the first impact panel may be designed such that it is curved to form a sine wave shape or another wave shape.

In the second embodiment, the second to sixth impact panels have the same shape as that of the first impact panel 410. However, it is possible to design the second to sixth impact panels such that they have different shapes from that of the first impact panel 410. In a brief description, it is not necessary to design the first to sixth impact panels so that they have the same shape.

In addition, no additional shock absorbing unit is installed on the upper surface of the uppermost impact panel or in each gap between the impact panels of the shock absorbing apparatus according to this second embodiment. However, it should be understood that a conventional shock absorbing means, such as an air bag, may be installed on the upper surface of the uppermost impact panel or in each gap between the impact panels.

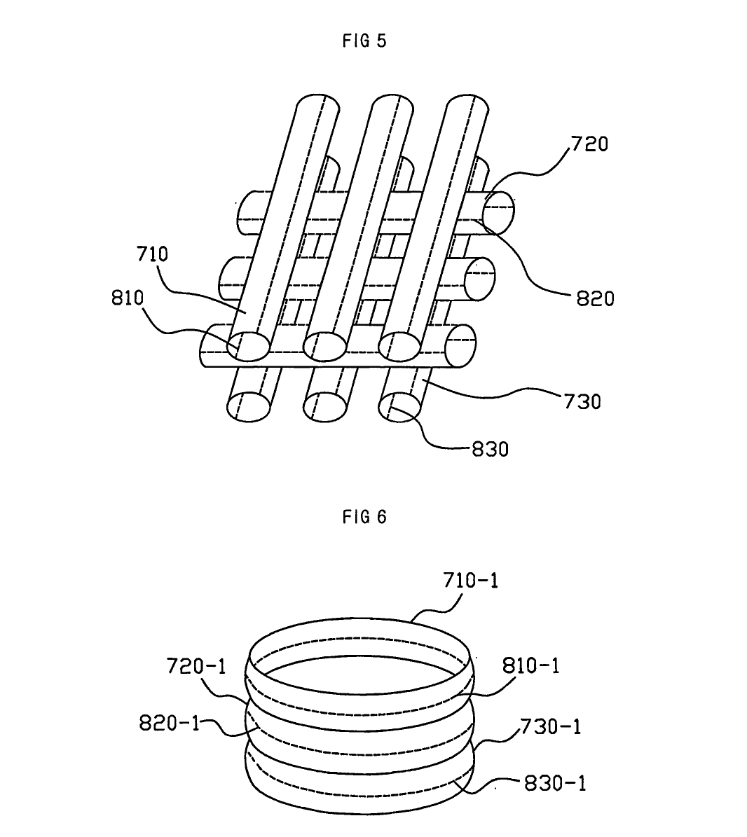

FIG. 5 shows a shock absorbing apparatus in accordance with the third embodiment of the present invention, which is used in automobiles typically applying horizontal impact to passengers in case of a collision, or in elevators typically applying vertical impact to passengers in case of a sudden drop.

FIG. 5 is a perspective view of the shock absorbing apparatus according to the third embodiment.

As shown in FIG. 5, the shock absorbing apparatus according to the third embodiment has first to third shock absorbing members 710, 720 and 730.

One or more first shock absorbing members, each having a cylindrical tubular shape as best seen in FIG. 5, are jointed to the second members in intersectional direction.

As shown in FIG. 5, the first shock absorbing members 710 are each engraved with a broken line 810 so as to crash along the broken line 810 into pieces to absorb impact in case of an application of impact higher than a predetermined reference level thereto. The broken line 810 of each first shock absorbing member 710 straightly extends in parallel to the axis of the shock absorbing members.

In the same manner, one or more second shock absorbing members 720 are jointed to the third members 730 in intersectional direction.

Each of the second to third shock absorbing members 720 and 730 has a cylindrical tubular shape as shown in FIG. 5. In addition, each of the second to third shock absorbing members is engraved with a broken line so as to crash along the broken line into pieces to stepwise absorb impact in case of an application of impact thereto. The broken lines of the second to third shock absorbing members each straightly extend in parallel to the axis of the shock absorbing members in the same manner as that described for the first broken line 810.

The operational effect of the shock absorbing apparatus according to the third embodiment will be described herein below with reference to FIG. 5.

When a weighted material primarily collides against and applies an impact to the first shock absorbing members 710, the members 710 absorb a part of the impact applied to the members 710. In such a case, when the impact applied to the members 710 exceeds a predetermined reference level, the first shock absorbing members 710 are broken along the first broken lines 810 into pieces.

In such a case, the impact energy absorbed by the first shock absorbing members 710 is determined by the depth and shape of the engraved broken line 810. That is, the impact energy absorbed by the first shock absorbing members 710 is reduced in inverse proportion to the depth of the first broken line 810. This means that the deeper the first broken line 810 is, the less impact energy is absorbed by the first shock absorbing members 710. Therefore, it is possible to control the impact energy absorbed at a first shock absorbing stage, performed by the first shock absorbing members 710, by controlling the depth and shape of the engraved first broken line 810.

When the weighted material with momentum attenuated by the first shock absorbing members 710 secondarily collides against and applies an impact to the shock absorbing members 720, the second shock absorbing members 720 absorb a part of the impact at a second shock absorbing stage in the same manner as that described for the first shock absorbing stage. In such a case, the second shock absorbing members 720 are broken along the second broken lines into pieces, and absorb a part of the impact applied to the second shock absorbing members 720.

In the same manner, a third shock absorbing stage is sequentially performed to stepwise absorb impact energy, and so the shock absorbing apparatus does not absorb an excessively high impact at once.

In the third embodiment, each shock absorbing member has a cylindrical tubular shape. However, it is possible to have another shape in place of the cylindrical tubular shape.

In the third embodiment, each broken line of the shock absorbing member straightly extends in parallel to the axis of the member. However, it is possible to have some angle from the axis of the tube.

In the third embodiment, the shock absorbing apparatus has three shock absorbing members. However, it should be understood that the number of shock absorbing members of the apparatus may be changed as desired. That is, the apparatus of this invention may have two or less absorbing members or four or more absorbing members if necessary.

FIG. 6 shows a shock absorbing apparatus in accordance with the fourth embodiment of the present invention, which is used in automobiles typically applying horizontal impact to passengers in case of a collision, or in elevators typically applying vertical impact to passengers in case of a sudden drop.

FIG. 6 is a perspective view of the shock absorbing apparatus according to the fourth embodiment.

As shown in FIG. 6, the shock absorbing apparatus according to the fourth embodiment has first to third shock absorbing members 710-1, 720-1 and 730-1.

The first shock absorbing member 710-1, having a toroidal tubular shape as best seen in FIG. 6, is jointed to the second absorbing member 720-1.

As shown in FIG. 6, the first shock absorbing member 710-1 is engraved with a broken line 810-1 so as to crash along the broken line 810-1 into pieces to absorb impact in case of an application of impact higher than a predetermined reference level thereto. The broken line 810-1 of the first shock absorbing member 710-1 straightly extends in parallel to the inner axis of the shock absorbing member.

In the same manner, the second shock absorbing member 720-1 is jointed to the third member 730-1.

Each of the second to third shock absorbing members 720-1 and 730-1 has a toroidal tubular shape as shown in FIG. 6. In addition, each of the second to third shock absorbing members is engraved with a broken line so as to crash along the broken line into pieces to stepwise absorb impact in case of an application of impact thereto. The broken lines of the second to third shock absorbing members each straightly extend in parallel to the inner axis of the shock absorbing members in the same manner as that described for the first broken line 810-1.

For the operational effect of the shock absorbing apparatus according to the fourth embodiment will be the same as that of the third embodiment, the explanation can be abbreviated.

In the fourth embodiment, each shock absorbing member has a toroidal tubular shape. However, it is possible to have another shape in place of the toroidal tubular shape.

In the fourth embodiment, each broken line of the shock absorbing member straightly extends in parallel to the inner axis of the member. However, it is possible to have some angle from the inner axis of the member.

In the fourth embodiment, the shock absorbing apparatus has three shock absorbing members. However, it should be understood that the number of shock absorbing members of the apparatus may be changed as desired. That is, the apparatus of this invention may have two or less absorbing members or four or more absorbing members if necessary.

### INDUSTRIAL APPLICABILITY

As described above, the present invention provides a shock absorbing apparatus, which has broken lines engraved on its impact panels or its shock absorbing members. In case of an application of impact higher than a predetermined reference level, the impact panels or the shock absorbing members sequentially crash along their broken lines into pieces, thus stepwise absorbing impact energy. The shock absorbing apparatus of this invention thus stepwise absorbs and attenuates impact in case of a collision of automobiles or a sudden drop of elevators to protect passengers.

In accordance with an embodiment of this invention, two or more closed broken lines are engraved on each impact panel and have different depths such that the broken lines become deeper in a direction from the outermost broken line to the innermost broken line, thus appropriately controlling impact energy to be stepwise absorbed by the impact panels, in accordance with impacted areas on the panels.

1. An apparatus for absorbing shock, comprising:
two or more impact panels; and
a plurality of shock absorbing members installed between said impact panels, and each engraved with a broken line so as to crash along the broken line to absorb impact in case of an application of the impact thereto.

2. The apparatus according to claim 1, wherein the broken lines engraved on said shock absorbing members include a broken line straightly extending in parallel to the impact panels.

3. The apparatus according to claim 2, wherein said shock absorbing members include a rectangular panel-shaped shock absorbing member jointed to two neighboring impact panels at its two opposite edges.

4. The apparatus according to claim 3, wherein said rectangular panel-shaped shock absorbing member is jointed to the two neighboring impact panels to form an I-shaped cross-section.

5. The apparatus according to claim 2, wherein said shock absorbing members include a tubular-shaped shock absorbing member jointed to two neighboring impact panels at its opposite sides.

6. The apparatus according to claim 5, wherein said tubular-shaped shock absorbing member is a cylindrical tubular-shaped shock absorbing member jointed to the two neighboring impact panels to form a [symbol] -shaped cross-section.

7. An apparatus for absorbing shock, comprising:
one or more impact panels arranged in parallel to each other, and each engraved with a broken line so as to crash along the broken line to absorb impact in case of an application of the impact thereto; and
a panel support member supporting the parallely arranged impact panels.

8. The apparatus according to claim 7, wherein the broken lines engraved on said impact panels include one or more closed broken lines extending along an entire edge of each impact panel.

9. The apparatus according to claim 8, wherein the number of closed broken lines engraved on each of the impact panels is two or more, with depths of said two or more closed broken lines of each impact panel being different from each other such that the broken lines become deeper in a direction from an outermost broken line to an innermost broken line.

10. The apparatus according to any one of claims 7 to 9, further comprising additional shock absorbing means, such as an air bag, is installed on an upper surface of an uppermost impact panel.

11. An apparatus for absorbing shock;
wherein two or more tubular-shaped shock absorbing members arranged to each other, and each engraved with a broken line so as to crash along the broken line to absorb impact in case of an application of the impact thereto.

12. The apparatus according to claim 11, wherein the broken lines engraved on said shock absorbing members include a broken line straightly extending in parallel to the axis, and the upper shock absorbing members and the lower shock absorbing members are arranged in intersectional direction.

13. The apparatus according to claim 11, wherein the shock absorbing members are toroidal shaped, and the broken lines engraved on said shock absorbing members include a broken line straightly extending in parallel to the inner axis of toroid.
